(19) United States
(12) Patent Application Publication
(10) Pub. No.: US 2025/0124184 A1
(43) Pub. Date: Apr. 17, 2025

(54) SYSTEM FOR ESTIMATING GROWTH OF FISH BASED ON DYNAMIC FISH GROWTH MODEL, METHOD FOR ESTIMATING GROWTH OF FISH USING THE SAME

(71) Applicant: PUKYONG NATIONAL UNIVERSITY INDUSTRY-UNIVERSITY COOPERATION FOUNDATION, Busan (KR)

(72) Inventors: Jeong Hwan PARK, Hail-myeon (KR); Young Hun LEE, Busan (KR); Ji Soo KIM, Gangneung-si (KR); Geoun Woo PARK, Busan (KR); Jae Man LEE, Changwon-si (KR)

(73) Assignee: PUKYONG NATIONAL UNIVERSITY INDUSTRY-UNIVERSITY COOPERATION FOUNDATION, Busan (KR)

(21) Appl. No.: 18/523,253

(22) Filed: Nov. 29, 2023

(30) Foreign Application Priority Data
Oct. 17, 2023 (KR) 10-2023-0138739

(51) Int. Cl. G06F 30/20; G06F 111/10

(52) U.S. Cl. CPC G06F 30/20; G06F 2111/10

(57) ABSTRACT

A device and method for estimating fish growth based on a modified fish growth model. The device includes a growth factor data input unit configured to receive growth factor data including an initial average weight Wi, a final average weight Wf, a total supplied feed amount F, and a rearing period D about a growth estimation target fish; a first growth information calculation unit configured to apply the growth factor data received from the growth factor data input unit to the modified fish growth model to calculate first growth information of the growth estimation target fish based on the modified fish growth model; and a display for outputting the first growth information calculated by the first growth information calculation unit on a screen thereof.

### CROSS-REFERENCE TO RELATED APPLICATION

This application claims a benefit under 35 U.S.C. § 119 (a) of Korean Patent Application No. 10-2023-0138739 filed on October 17, on the Korean Intellectual Property Office, the entire disclosure of which is incorporated herein by reference for all purposes.

### BACKGROUND

### 1. Field

The present disclosure relates to a device and method for estimating fish growth based on a modified fish growth model. More specifically, the present disclosure relates to a device and method for estimating fish growth in which fish growth may be more accurately estimated using a modified fish growth model that takes into account factors such as a feed supply amount, a rearing period, and a water temperature, etc. that affect the fish growth complexly.

### 2. Description of Related Art

Demand for seafood is rapidly increasing as the world population and animal protein consumption increase. The fishing industry which captures fish has reached its production limit due to climate change and indiscriminate overfishing. Due to this fact, aquaculture is currently the fastest growing food production sector in the world and is a key industry contributing to future food security. Not only does aquaculture provide an important source of protein, but it may also contribute to the natural ecosystem, such as restoring habitat around fish farms and replenishing wild populations. However, with the development of intensive aquaculture, concerns are being raised that the increase in aquaculture waste may affect productivity within the farm and the surrounding aquatic ecosystem. In addition, problems such as the spread of pathogens, increased antibiotic resistance, overfishing of fishery resources for live feed production, and introduction of invasive species are accompanied. Therefore, efforts are needed to ensure the social and environmental sustainability of the aquaculture industry.

Accordingly, interest in and importance of the recirculating aquaculture system (RAS), which is compatible with intensive fish production and environmental sustainability, is increasing. The RAS refers to a system that treats and reuses water polluted by physical, chemical and biological wastes discharged from fish farms so that aquaculture organisms may survive therein. The RAS reduces water use, treats and recycles waste, enables hygienic disease management and biological pollution control in a closed environment, and maintains a constant environment optimal for fish growth.

A water temperature is one of the most important environmental factors affecting fish growth, metabolism, and essentially feed intake. The RAS may maintain this water temperature at a constant level, enabling optimal growth via active feed intake by fish. Additionally, in order to achieve optimal growth and reduce farm operating costs, an adaptive feeding system that supplies the feed in a timely manner is being introduced. In this way, the RAS has a low impact on the external environment, minimizing external environmental pollution, which is a problem in the current aquaculture industry, and at the same time, adjusts the internal environment to create an optimal environment for fish growth. Thus, the RAS has become technology essential for a sustainable and economical future aquaculture industry.

Growth is defined as the gradual increase in a body weight through the coordination of a biological system over time. Growth in which the size of an organism changes with age is the sum of the most basic and important biological processes that integrate numerous processes and form the life cycle of a fish. Fish growth is a very complex process that is the result of a series of behavioral and physiological processes that occur when feed is consumed and nutrients are absorbed into the animal's tissues. Other water quality factors besides the fish's gender, age, stocking density, water temperature, and dissolved oxygen affect the growth of the fish, but feed quality and intake have the greatest influence. Fish growth is the most important factor related to economic profits in aquaculture. Therefore, in most aquaculture field conditions, it is essential to develop growth estimation and monitoring methods by measuring actual fish weight gain, feed intake rate, and growth efficiency under different environmental conditions. In general, models for monitoring and estimating fish growth may be roughly classified into a growth model which estimates growth based on the visible growth amount, which is the final result of physiological processes, and a bioenergetic model which estimates growth based on the feed supply and energy balance. In the aquaculture industry, the fish growth is mainly expressed using each of an absolute/relative growth rate model and a specific growth rate (SGR) model as the growth model. Each of the absolute/relative growth rate model and the specific growth rate (SGR) model is a numerical expression of growth under assumption of a specific relationship between a size and a time.

To maximize the growth efficiency of fish and improve the economic feasibility of fish farming, the best approach is to use a mathematical model based on a growth rate and a feed intake. The specific growth rate (SGR) model based on the growth rate is one of the most common growth measurement methods and is expressed based on a specific growth rate per unit weight of the fish. Another growth model based on the growth rate is a thermal unit growth coefficient (TGC) model which refers to a growth model obtained by correcting the SGR model by adding a water temperature variable thereto. A feed coefficient (FC) based on the feed intake and a weight gain is a value obtained by dividing the total feed intake by the weight gain and has an inverse relationship with feed efficiency. A FC model is of major interest in improving aquaculture sustainability via reduced feed costs and environmental impacts.

The growth models as mentioned above are currently mainly used in the aquaculture industry. However, each of the above models does not take into account all factor variables important to fish growth. Therefore, there is a limitation in estimating growth with a single growth model.

For example, the SGR model assumes that a body weight increases exponentially. In addition, the SGR model based on the growth rate takes into account the weight and length of the fish body and the rearing period, but does not take into account information on the feed intake which is one of the most important factors in fish growth. In general, the SGR model assumes feed saturation. However, when the feed supply is stopped or the feed supply amount is adjusted during the rearing period, an estimate of the fish body size or a production period using the existing SGR model may be inaccurate. In particular, the concept of the saturation varies depending on the feed supplier, so that the estimate based on the SGR model may not take into account the change in a growth rate according to the feed input amount.

The TGC model adds the water temperature as the variable to the variables used in the SGR model equation, and may provide more accurate information about the actual growth pattern of fish compared to the SGR model. However, like the SGR model, the TGC model does not take into account feed requirements. Fish are cold-blooded animals, and their metabolic rate and feed intake are greatly affected by the water temperature. The TGC model has the advantage of being able to correct the SGR model without reflecting the above affection. However, since the water temperature as the variable has been determined, the model may be biased in terms of comparison of the growth results under various environmental conditions.

On the other hand, the FC model only considers the feed intake and the fish body weight gain and fails to take into account the rearing period. Additionally, in fish farming, there is uncertainty in that the amount of the feed consumed by individual fish cannot be accurately measured. Despite its low accuracy, the FC has a clear negative correlation with growth, and is a relative indicator that only indicates the weight gain relative to the supplied feed amount. Thus, the FC model has limitations in figuring out the actual growth and condition of fish.

A prior art literature to the present disclosure includes Korean Patent Application Publication No. 10-2493984 2023.01.26)

### SUMMARY

A purpose of the present disclosure is to provide a device and method for estimating fish growth in which fish growth may be more accurately estimated using a modified fish growth model that takes into account factors such as a feed supply amount, a rearing period, and a water temperature, etc. that affect the fish growth complexly.

A purpose of the present disclosure is to provide a device and method for estimating fish growth based on a modified fish growth model that may estimate fish growth using multiple growth models suitable for specific species or research, as obtained by supplementing existing growth models.

A purpose of the present disclosure is to provide a device and method for estimating fish growth based on a modified fish growth model that may present a reference and a range for identifying whether fish are actually raised and managed properly without problems at the farm site.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

A first aspect of the present disclosure provides a device for estimating fish growth based on a modified fish growth model, the device comprising: a growth factor data input unit configured to receive growth factor data including an initial average weight Wi, a final average weight Wf, a total supplied feed amount F, and a rearing period D about a growth estimation target fish; a first growth information calculation unit configured to apply the growth factor data received from the growth factor data input unit to the modified fish growth model to calculate first growth information of the growth estimation target fish based on the modified fish growth model; and a display for outputting the first growth information calculated by the first growth information calculation unit on a screen thereof.

In one implementation of the device for estimating fish growth based on the modified fish growth model, the first growth information calculation unit is configured to calculate a specific growth rate (SGR) value based on a modified specific growth rate (SGR) model including the total supplied feed amount F as a variable.

In one implementation of the device for estimating fish growth based on the modified fish growth model, the modified specific growth rate (SGR) model is expressed based on a following Mathematical Equation 5:

$$SGR = \frac{100 ∘ Ln ( \frac{F}{FC ∘ {W}_{i}} + 1 )}{D} \qquad [ Mathematical Equation 5 ]$$

where Ln( ) is a logarithmic function, and FC=F/WG=F/(Wf−Wi).

In one implementation of the device for estimating fish growth based on the modified fish growth model, the growth factor data input unit is configured to receive the initial average weight Wi, the final average weight Wf, the total supplied feed amount F, and the rearing period D, wherein the first growth information calculation unit is configured to calculate a feed coefficient (FC) value based on a modified feed coefficient (FC) model including the rearing period D as a variable.

In one implementation of the device for estimating fish growth based on the modified fish growth model, the modified feed coefficient (FC) model is expressed based on a following Mathematical Equation 7:

$$FC = \frac{F}{[ Exp ( \frac{SGR ∘ D}{100} ) - 1 ] ∘ {W}_{i}} \qquad [ Mathematical Equation 7 ]$$

where Exp( ) is an exponential function, and SGR=(LnWf−LnWi)×100/D.

In one implementation of the device for estimating fish growth based on the modified fish growth model, the growth factor data input unit is configured to the initial average weight Wi, the final average weight Wf, the total supplied feed amount F, an average water temperature T, and the rearing period D, wherein the first growth information calculation unit is configured to calculate a thermal unit growth coefficient (TGC) value based on a modified thermal unit growth coefficient (TGC) model including the total supplied feed amount F as a variable.

In one implementation of the device for estimating fish growth based on the modified fish growth model, the modified thermal unit growth (TGC) model is expressed based on a following Mathematical Equation 12:

$$TGC = [ {( \frac{F}{FC ∘ {W}_{i}} + 1 )}^{\frac{1}{3}} - 1 ] \times \frac{1000 ∘ {W}_{i}^{\frac{1}{3}}}{T ∘ D} \qquad [ Mathematical Equation 12 ]$$

where FC=F/WG=F/(Wf−Wi).

In one implementation of the device for estimating fish growth based on the modified fish growth model, the growth factor data input unit is configured to the initial average weight Wi, the final average weight Wf, the total supplied feed amount F, the average water temperature T, and the rearing period D, wherein the first growth information calculation unit is configured to calculate a feed coefficient (FC) value based on a modified feed coefficient (FC) model including the rearing period D and the average water temperature T as variables.

In one implementation of the device for estimating fish growth based on the modified fish growth model, the modified feed coefficient (FC) model is expressed based on a following Mathematical Equation 13:

$$FC = \frac{F}{[ {( \frac{TGC ∘ T ∘ D}{1000 ∘ {W}_{i}^{\frac{1}{3}}} + 1 )}^{3} - 1 ] ∘ {W}_{i}} \qquad [ Mathematical Equation 13 ]$$

where TGC=(Wf1/3−Wi1/3)×1000/(T×D).

In one implementation of the device for estimating fish growth based on the modified fish growth model, the device for estimating fish growth based on the modified fish growth model further comprises: a second growth information calculation unit configured to calculate second growth information of the growth estimation target fish based on a non-modified growth model; and a verification unit configured to verify reliability of the modified fish growth model based on a comparing result between the first growth information calculated by the first growth information calculation unit and the second growth information calculated by the second growth information calculation unit.

In one implementation of the device for estimating fish growth based on the modified fish growth model, in response to that a similarity between the first growth information and the second growth information is in a range between a preset first threshold value and a preset second threshold value, the verification unit is configured to determine that the modified fish growth model is reliable.

A second aspect of the present disclosure provides a method for estimating fish growth based on a modified fish growth model, the method comprising: receiving, by a growth factor data input unit, growth factor data about a growth estimation target fish; applying, by a first growth information calculation unit, the growth factor data received from the growth factor data input unit to the modified fish growth model to calculate first growth information of the growth estimation target fish based on the modified fish growth model; and outputting, by a display, the first growth information calculated by the first growth information calculation unit on a screen thereof.

In one implementation of the method for estimating fish growth based on the modified fish growth model, the method for estimating fish growth based on the modified fish growth model further comprises: calculating, by a second growth information calculation unit, second growth information of the growth estimation target fish based on a non-modified growth model; and verifying, by a verification unit, reliability of the modified fish growth model based on a comparing result between the first growth information calculated by the first growth information calculation unit and the second growth information calculated by the second growth information calculation unit.

In one implementation of the method for estimating fish growth based on the modified fish growth model, receiving the growth factor data includes receiving an initial average weight Wi, a final average weight Wf, a total supplied feed amount F, and a rearing period D, wherein calculating the first growth information includes calculating a specific growth rate (SGR) value based on a modified specific growth rate (SGR) model including the total supplied feed amount F as a variable.

In one implementation of the method for estimating fish growth based on the modified fish growth model, receiving the growth factor data includes receiving an initial average weight Wi, a final average weight Wf, a total supplied feed amount F, and a rearing period D, wherein calculating the first growth information includes calculating a feed coefficient (FC) value based on a modified feed coefficient (FC) model including the rearing period D as a variable.

In one implementation of the method for estimating fish growth based on the modified fish growth model, receiving the growth factor data includes receiving an initial average weight Wi, a final average weight Wf, a total supplied feed amount F, an average water temperature T, and a rearing period D, wherein calculating the first growth information includes calculating a thermal unit growth coefficient (TGC) value based on a modified thermal unit growth coefficient (TGC) model including the total supplied feed amount F as a variable.

In one implementation of the method for estimating fish growth based on the modified fish growth model, receiving the growth factor data includes receiving an initial average weight Wi, a final average weight Wf, a total supplied feed amount F, an average water temperature T, and a rearing period D, wherein calculating the first growth information includes calculating a feed coefficient (FC) value based on a modified feed coefficient (FC) model including the rearing period D and the average water temperature T as variables.

As described above, using the device and method for estimating fish growth based on the modified fish growth model according to the present disclosure, the fish growth may be more accurately estimated using the modified fish growth model that takes into account factors such as a feed supply amount, a rearing period, and a water temperature, etc. that affect the fish growth complexly.

Further, the device and method for estimating fish growth based on the modified fish growth model according to the present disclosure may estimate the fish growth using the multiple growth models suitable for specific species or research, as obtained by supplementing the existing growth models.

Further, the device and method for estimating fish growth based on the modified fish growth model according to the present disclosure may present the reference and the range for identifying whether fish are actually raised and managed properly without problems at the farm site.

Effects of the present disclosure are not limited to the effects mentioned above, and other effects not mentioned will be clearly understood by those skilled in the art from the descriptions below.

### BRIEF DESCRIPTION OF DRAWINGS

FIG. 1 is a diagram showing a configuration of a device for estimating fish growth based on a modified fish growth model according to an embodiment of the present disclosure.

FIG. 2 is a schematic diagram of a recirculating aquaculture system (RAS).

FIG. 3 is a table summarizing different feed rates for four experimental groups.

FIG. 4 shows a water quality analysis result for each of experimental groups for a 8-weeks fish rearing period.

FIG. 5 shows a growth result (total weight, stocking density, SGR, and TGC) for each experimental group measured after 8 weeks of fish rearing.

FIG. 6 shows a variation specific growth rate (variation SGR) value for each experimental group measured after 8 weeks of fish rearing.

FIG. 7 is a diagram comparing a non-modified specific growth rate model value (actual SGR) and modified specific growth rate model value (Prediction SGR) for each experimental group.

FIG. 8 shows a modified thermal unit growth coefficient (Variation TGC) model value for each experimental group measured after 8 weeks of fish rearing.

FIG. 9 is a diagram comparing a non-modified thermal unit growth coefficient model value (Actual TGC) with a modified thermal unit growth coefficient model value (Prediction TGC) for each experimental group.

FIG. 10 shows a modified feed coefficient (FC) model value for each experimental group measured after 8 weeks of fish rearing.

FIG. 11 is a diagram comparing a non-modified feed coefficient model value (Actual FC) with a modified feed coefficient model value (Prediction FC) for each experimental group.

FIG. 12 is a diagram analyzing a similarity between a non-modified growth model value and a modified fish growth model value for each experimental group.

FIG. 13 is a flowchart for illustrating a method for estimating fish growth based on a modified fish growth model according to one embodiment of the present disclosure.

### DETAILED DESCRIPTIONS

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may include within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may be actually executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated. The features of the various embodiments of the present disclosure may be partially or entirely combined with each other, and may be technically associated with each other or operate with each other. The embodiments may be implemented independently of each other and may be implemented together in an association relationship.

Some embodiments may be described in terms of functional block components and various processing steps. Some or all of these functional blocks may be implemented as various numbers of hardware and/or software components that perform specific functions. For example, the functional blocks of the present disclosure may be implemented by one or more microprocessors, or may be implemented by circuit components for a given function. The functional blocks of the present disclosure may be implemented in a variety of programming or scripting languages. The functional blocks of the present disclosure may be implemented as algorithms executed on one or more processors. A function performed by a function block of the present disclosure may be performed by a plurality of function blocks, or functions performed by a plurality of function blocks of the present disclosure may be performed by a single function block. Furthermore, the present disclosure may employ prior art techniques for electronic configuration setting, signal processing, and/or data processing.

Terms such as ‘ . . . unit’ as used hereinafter mean a unit that processes at least one function or operation, and which may be implemented in hardware or software, or a combination of hardware and software.

Various embodiments of the present disclosure as described below are based on a hardware scheme by way of example. However, the present disclosure is not limited thereto. Because the various embodiments of the present disclosure include using both hardware and software, the various embodiments of the present disclosure do not exclude a software-based scheme.

Hereinafter, the specific details for implementing the device for estimating fish growth based on the modified fish growth model and the method for estimating fish growth based on the modified fish growth model according to the present disclosure are described as follows.

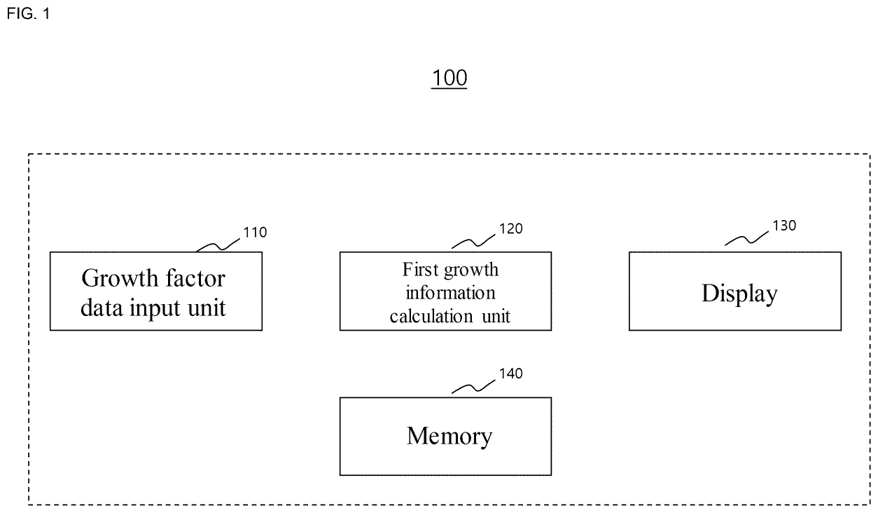

FIG. 1 is a diagram showing a configuration of a device for estimating fish growth based on a modified fish growth model according to an embodiment of the present disclosure.

Referring to FIG. 1, a device 100 for estimating fish growth based on a modified fish growth model includes a growth factor data input unit 110, a first growth information calculation unit 120, a display 130, and a memory 140.

The device 100 for estimating fish growth based on a modified fish growth model may estimate the growth of the fish using a modified fish growth model that complexly takes into account factors such as a feed supply, a rearing period, and a water temperature that affect the growth of a growth estimation target fish.

The growth factor data input unit 110 receives growth factor data about the growth estimation target fish. For example, the growth factor data may include at least one of followings: an initial average weight Wi, a final average weight Wf, a total supplied feed amount F, average water temperature T, and a rearing period D. The growth factor data that is input to the input unit may vary depending on a type of a growth model.

In one embodiment, the growth factor data input unit 110 may receive the growth factor data under user control. In another embodiment, the growth factor data input unit 110 may read the growth factor data stored in the memory 140 therefrom under user control. In the memory 140, the growth factor data input under user control or the growth factor data measured via a sensor at the fish farm may be pre-stored as database. For example, the memory 140 may pre-store therein the initial average weight Wi, the final average weight Wf, the total supplied feed amount F, the average water temperature T, and the rearing period D of the fish as measured directly by the user. Alternatively, the growth factor data may be automatically measured and pre-stored in the memory 140. For example, the memory 140 may pre-store therein the initial average weight Wi and the final average weight Wf calculated based on a size of the growth estimation target fish photographed through the fish farm's image sensor, the total supplied feed amount F measured by an adaptive feeding system, the average water temperature T of the fish farm measured via a temperature sensor, and the rearing period D in the fish farm as calculated via a clock.

The first growth information calculation unit 120 applies the data input through the growth factor data input unit 110 to the modified fish growth model in which growth information of the growth estimation target fish is calculated according to the modified fish growth model.

The modified fish growth model may be calculated as follows.

The variables of the SGR model may be the final average weight Wf, the initial average weight Wi, and the rearing period D, and the SGR model may apply a log function to Wf and Wi, and may be defined based on a following Mathematical Equation 1. The variables of the FC model may be the final average weight Wf, the initial average weight Wi, and the total supplied feed amount F, and the FC model may divide F by the weight gain, and may be defined based on a following Mathematical Equation 3. The variables of the TGC model may include the average water temperature T, the final average weight Wf, the initial average weight Wi, and the rearing period D. The TGC model may be defined as a following Mathematical Equation 10.

The common variables in the expressions of the three models SGR, TGC, and FC are the final average weight Wf and the initial average weight Wi. Each of the SGR and TGC model expressions does not include the total supplied feed amount F as the variable. The FC model expression does not include the rearing period D and the average water temperature T as the variable.

To create a modified SGR model that includes the total supplied feed amount F as the variable, Wf/Wi as the common variable of the SGR model and the FC model may be displaced to a left term and then the equation may be developed. A following Mathematical Equation 2 shows the process of calculating the SGR model in which Wf/Wi has been displaced to the left term, and a following Mathematical Equation 4 shows the process of calculating the FC model in which Wf/Wi has been displaced to the left term.

$$SGR = \frac{Ln {W}_{f} - Ln {W}_{i}}{D} \times 100 \qquad [ Mathematical Equation 1 ]$$

where Ln( ) is a logarithmic function, Wi is the initial average weight, Wf is the final average weight, and D is the rearing period.

$$SGR = \frac{Ln {W}_{f} - Ln {W}_{i}}{D} \times 100 \\ ⇒ Ln {W}_{f} - Ln {W}_{i} = \frac{SGR \cdot D}{100} \\ ⇒ Ln ( \frac{{W}_{f}}{{W}_{i}} ) = \frac{SGR \cdot D}{100} \\ \frac{{W}_{f}}{{W}_{i}} = Exp ( \frac{SGR \cdot D}{100} ) \qquad [ Mathematical Equation 2 ]$$

$$FC = \frac{F}{WG} = \frac{F}{{W}_{f} - {W}_{i}} \qquad [ Mathematical Equation 3 ]$$

where F represents the total supplied feed amount, and WG represents the weight gain (Wf−Wi).

$$FC = \frac{F}{WG} = \frac{F}{{W}_{f} - {W}_{i}} \\ ⇒ {W}_{f} - {W}_{i} = \frac{F}{FC} \\ ⇒ \frac{{W}_{f}}{{W}_{i}} - \frac{{W}_{i}}{{W}_{i}} = \frac{F}{FC \cdot {W}_{i}} \\ \frac{{W}_{f}}{{W}_{i}} = \frac{F}{FC \cdot {W}_{i}} + 1 \qquad [ Mathematical Equation 4 ]$$

The right terms to Wf/Wi of the Mathematical Equation 2 obtained by developing the SGR model and the Mathematical Equation 4 obtained by developing the FC model may be combined with each other to calculate the modified SGR model (Mathematical Equation 5) including the total supplied feed amount F as the variable. A Mathematical Equation 6 shows a process of calculating the modified SGR model including the total supplied feed amount F as a variable.

$$SGR = \frac{100 \cdot Ln ( \frac{F}{FC \cdot {W}_{i}} + 1 )}{D} \qquad [ Mathematical Equation 5 ]$$

$$\frac{SGR \cdot D}{100} = Ln ( \frac{F}{FC \cdot {W}_{i}} + 1 ) \\ ⇒ SGR = \frac{100 \cdot Ln ( \frac{F}{FC \cdot {W}_{i}} + 1 )}{D} \qquad [ Mathematical Equation 6 ]$$

Furthermore, the right terms to Wf/Wi of the Mathematical Equation 2 obtained by developing the SGR model and the Mathematical Equation 4 obtained by developing the FC model may be combined with each other to calculate a modified FC model (Mathematical Equation 7) including the rearing period D as a variable and a modified model expressed based on Mathematical Equation 8 as a total supplied feed amount F estimation model including the rearing period D as a variable. A Mathematical Equation 9 shows the process of calculating the modified FC model including the rearing period D as a variable and the total supplied feed amount F estimation model including the rearing period D as a variable.

$$FC = \frac{F}{[ Exp ( \frac{SGR \cdot D}{100} ) - 1 ]} \cdot {W}_{i} \qquad [ Mathematical Equation 7 ]$$

$$F = [ Exp ( \frac{SGR \cdot D}{100} ) - 1 ] \cdot {W}_{i} \cdot FC \qquad [ Mathematical Equation 8 ]$$

$$\frac{F}{FC \cdot {W}_{i}} = Exp ( \frac{SGR \cdot D}{100} ) - 1 \\ ⇒ FC = \frac{F}{[ Exp ( \frac{SGR \cdot D}{100} ) - 1 ] \cdot {W}_{i}} \\ ⇒ F = [ Exp ( \frac{SGR \cdot D}{100} ) - 1 ] \cdot {W}_{i} \cdot FC \qquad [ Mathematical Equation 9 ]$$

The TGC model may be defined as a following Mathematical Equation 10. To create a modified TGC model that includes the total supplied feed amount F as a variable, Wf/Wi which is a common variable of the TGC and FC models may be displaced to the left term and then the equation may be developed. A following Mathematical Equation 11 shows the process of calculating the TGC model in which Wf/Wi has been displaced to the left term.

$$TCG = \frac{{W}_{f}^{\frac{1}{3}} - {W}_{i}^{\frac{1}{3}}}{T \cdot D} \times 1000 \qquad [ Mathematical Equation 10 ]$$

where Wi represents the initial average weight, Wf represents the final average weight, T represents the average water temperature, and D represents the rearing period.

$$TCG = \frac{{W}_{f}^{\frac{1}{3}} - {W}_{i}^{\frac{1}{3}}}{T \cdot D} \times 1000 \\ ⇒ {W}_{f}^{\frac{1}{3}} - {W}_{i}^{\frac{1}{3}} = \frac{TGC \cdot T \cdot D}{1000} \\ ⇒ \frac{{W}_{f}^{\frac{1}{3}}}{{W}_{i}^{\frac{1}{3}}} - \frac{{W}_{i}^{\frac{1}{3}}}{{W}_{i}^{\frac{1}{3}}} = \frac{TGC \cdot T \cdot D}{1000 \cdot {W}_{i}^{\frac{1}{3}}} \\ ⇒ {( \frac{{W}_{f}}{{W}_{i}} )}^{\frac{1}{3}} = \frac{TGC \cdot T \cdot D}{1000 \cdot {W}_{i}^{\frac{1}{3}}} + 1 \\ ⇒ \frac{{W}_{f}}{{W}_{i}} = {( \frac{TGC \cdot T \cdot D}{1000 \cdot {W}_{i}^{\frac{1}{3}}} + 1 )}^{3} \qquad [ Mathematical Equation 11 ]$$

The right terms to Wf/Wi of the Mathematical Equation 4 obtained by developing the FC model, and Mathematical Equation 11 obtained by developing the TGC model may be combined with each other to calculate a modified TGC model (Mathematical Equation 12) including the total supplied feed amount F as a variable, a modified FC model (Mathematical Equation 13) including the rearing period D as a variable and the average water temperature T as a variable, a total supplied feed amount F estimation model including rearing period D as a variable and average water temperature T as a variable (Mathematical Equation 14), and an average water temperature T estimation model (Mathematical Equation 15) including the total supplied feed amount F as a variable. A Mathematical Equation 16 shows a process in which the right terms to Wf/Wi of the Mathematical Equation 4 obtained by developing the FC model, and Mathematical Equation 11 obtained by developing the TGC model may be combined with each other to calculate a modified TGC model (Mathematical Equation 12) including the total supplied feed amount F as a variable, a modified FC model (Mathematical Equation 13) including the rearing period D as a variable and the average water temperature T as a variable, a total supplied feed amount F estimation model including rearing period D as a variable and average water temperature T as a variable (Mathematical Equation 14), and an average water temperature T estimation model (Mathematical Equation 15) including the total supplied feed amount F as a variable.

$$TGC = [ {( \frac{F}{FC \cdot {W}_{i}} + 1 )}^{\frac{1}{3}} - 1 ] \times \frac{1000 \cdot {W}_{i}^{\frac{1}{3}}}{T \cdot D} \qquad [ Mathematical Equation 12 ]$$

$$FC = \frac{F}{[ {( \frac{TGC \cdot T \cdot D}{1000 \cdot {W}_{i}^{\frac{1}{3}}} + 1 )}^{3} - 1 ] \cdot {W}_{i}} \qquad [ Mathematical Equation 13 ]$$

$$F = FC \cdot [ ( \frac{TGC \cdot T \cdot D}{1000 \cdot {W}_{i}^{\frac{1}{3}}} ) - 1 ] \cdot {W}_{i} \qquad [ Mathematical Equation 14 ]$$

$$T = ( \frac{F}{FC \cdot {W}_{i}} + 1 ) \cdot ( \frac{1000 \cdot {W}_{i}^{\frac{1}{3}}}{TGC \cdot D} ) \qquad [ Mathematical Equation 15 ]$$

$${( \frac{TGC \cdot T \cdot D}{1000 \cdot {W}_{i}^{\frac{1}{3}}} + 1 )}^{3} = \frac{F}{FC \cdot {W}_{i}} + 1 \\ ⇒ TGC = [ {( \frac{F}{FC \cdot {W}_{i}} + 1 )}^{\frac{1}{3}} - 1 ] \times \frac{1000 \cdot {W}_{i}^{\frac{1}{3}}}{T \cdot D} \\ ⇒ FC = \frac{F}{[ {( \frac{TGC \cdot T \cdot D}{1000 \cdot {W}_{i}^{\frac{1}{3}}} + 1 )}^{3} - 1 ] \cdot {W}_{i}} \\ ⇒ F = FC \cdot [ ( \frac{TGC \cdot T \cdot D}{1000 \cdot {W}_{i}^{\frac{1}{3}}} ) - 1 ] \cdot {W}_{i} \\ ⇒ T = ( \frac{F}{FC \cdot {W}_{i}} + 1 ) \cdot ( \frac{1000 \cdot {W}_{i}^{\frac{1}{3}}}{TGC \cdot D} ) \qquad [ Mathematical Equation 16 ]$$

Referring again to FIG. 1, the first growth information calculation unit 120 may apply the initial average weight Wi, the final average weight Wf, the total supplied feed amount F, and the rearing period D as received through the growth factor data input unit 110 to a modified specific growth rate (SGR) model including the total supplied feed amount F as a variable to calculate a specific growth rate (SGR) value.

The modified specific growth rate (SGR) model including the total supplied feed amount F as a variable may be expressed based on the following Mathematical Equation 5.

$$SGR = \frac{100 \cdot Ln ( \frac{F}{FC \cdot {W}_{i}} + 1 )}{D} \qquad [ Mathematical Equation 5 ]$$

where Ln( ) represents the logarithmic function, and FC=F/WG=F/(Wf−Wi).

In another embodiment, the first growth information calculation unit 120 may apply the initial average weight Wi, the final average weight Wf, the total supplied feed amount F, and the rearing period D as received via the growth factor data input unit 110 to a modified feed coefficient (FC) model including the rearing period D as a variable to calculate a feed coefficient (FC) value.

The modified feed coefficient (FC) model including the rearing period D as a variable may be expressed based on a following Mathematical Equation 7.

$$FC = \frac{F}{[ Exp ( \frac{SGR \cdot D}{100} ) - 1 ]} \cdot {W}_{i} \qquad [ Mathematical Equation 7 ]$$

where Exp( ) represents the exponential function, and SGR=(Ln(Wf)−Ln(Wi))×100/D.

In another embodiment, the first growth information calculation unit 120 may apply the initial average weight Wi, the final average weight Wf, the total supplied feed amount F, and the average water temperature T, and the rearing period D as received via the growth factor data input unit 110 to a modified thermal unit growth (TGC) model including the total supplied feed amount F as a variable to calculate a thermal unit growth coefficient (TGC) value.

The modified thermal unit growth (TGC) model including the total supplied feed amount F as a variable may be expressed based on a following Mathematical Equation 12.

$$TGC = [ {( \frac{F}{FC \cdot {W}_{i}} + 1 )}^{\frac{1}{3}} - 1 ] \times \frac{1000 \cdot {W}_{i}^{\frac{1}{3}}}{T \cdot D} \qquad [ Mathematical Equation 12 ]$$

where FC=F/WG=F/(Wf−Wi).

In another embodiment, the first growth information calculation unit 120 may apply the initial average weight Wi, the final average weight Wf, the total supplied feed amount F, the average water temperature T, and the rearing period D as received via the growth factor data input unit 110 to a modified feed coefficient (FC) model including the rearing period D and the average water temperature T as variables to calculate a feed coefficient (FC) value.

The modified feed coefficient (FC) model including the rearing period D and the average water temperature T as variables may be expressed based on a following Mathematical Equation 13.

$$FC = \frac{F}{[ {( \frac{TGC \cdot T \cdot D}{1000 \cdot {W}_{i}^{\frac{1}{3}}} + 1 )}^{3} - 1 ] \cdot {W}_{i}} \qquad [ Mathematical Equation 13 ]$$

where TGC=(Wf1/3−Wi1/3)×1000/(T×D).

The display 130 outputs the growth information calculated by the first growth information calculation unit 120 on a screen. For example, the display 130 may display the growth information value (e.g., specific growth rate (SGR) value, feed coefficient (FC) value, or thermal unit growth coefficient (TGC) value) as calculated by the first growth information calculation unit 120 on the screen.

The memory 140 may store therein a growth factor data value, modified fish growth model (e.g., modified specific growth rate (SGR) model, modified feed coefficient (FC) model, modified thermal unit growth (TGC) model, etc.) calculation algorithm data, system operation data, etc.

In one embodiment, the device 100 for estimating the growth of fish based on the modified fish growth model may further include a second growth information calculation unit (not shown) that calculates growth information of the growth estimation target fish based on a comparison target growth model, and a verification unit (not shown) that verifies the reliability of the modified fish growth model based on a comparing result between the first growth information calculated from the first growth information calculation unit 120 and the second growth information calculated from the second growth information calculation unit. For example, the second growth information calculation unit may apply the data input through the growth factor data input unit 110 to a non-modified growth model (non-modified SGR model, non-modified FC model, non-modified thermal unit growth coefficient (TGC) model) rather than the modified fish growth model to calculate the second growth information. For example, the non-modified SGR model may be expressed based on the Mathematical Equation 1, the non-modified FC model may be expressed based on the Mathematical Equation 3, and the non-modified thermal unit growth coefficient (TGC) model may be expressed based on the Mathematical Equation 10. The display 130 may output the first growth information calculated by the first growth information calculation unit 120 and the second growth information calculated by the second growth information calculation unit on the screen.

In response to that a similarity (the second growth information value/the first growth information value) between the first growth information and the second growth information is between a preset first threshold value (e.g., 0.9) and a preset second threshold value (e.g. 1.1), the verification unit may determine that the modified fish growth model is reliable. For example, when a similarity between the non-modified model value and the modified model value is within a specific reference range, it may be determined that the fish is actually growing normally in the field. In other words, the similarity between the non-modified model value and the modified model value may be used as a measure to identify whether the fish is actually growing normally.

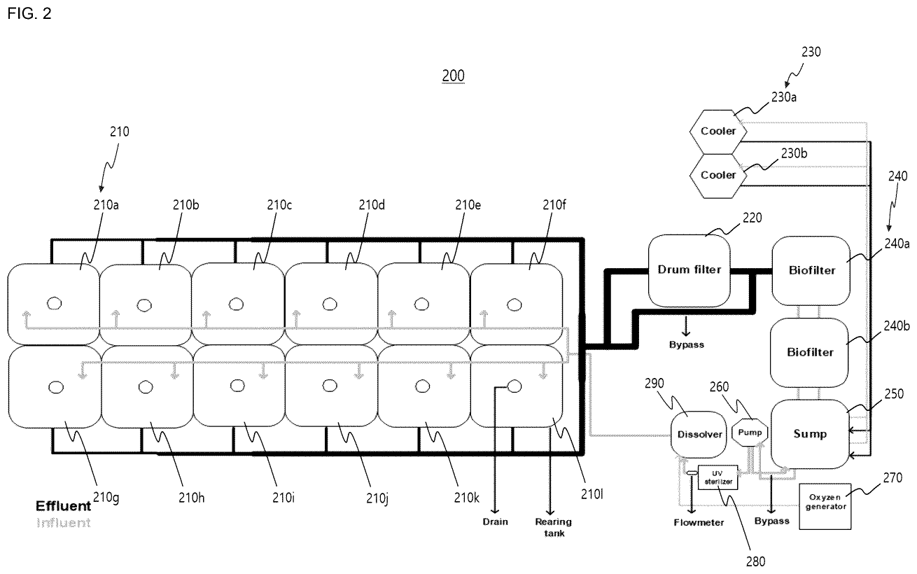

FIGS. 2 to 12 are diagrams illustrating examples of verifying the modified fish growth model through actual fish rearing experiments. Hereinafter, the present disclosure will describe the process of conducting an empirical rearing experiment targeting a rainbow trout using a rearing system as shown in FIG. 2.

FIG. 2 is a schematic diagram of a recirculating aquaculture system (RAS).

Referring to FIG. 2, the recirculating aquaculture system (RAS) 200 includes an aquaculture tank 210, a drum filter 220, a cooler 230, a biological filtration tank 240, a water storage tank 250, a pump 260, a pure oxygen generator 270, an UV sterilizer 280, and a dissolver 290.

The recirculating aquaculture system 200 used in the experimental example includes 12 round and square aquaculture tanks 210 (110×110×100 cm), one drum filter 220 (0.55 Kw), 2 biological filtration tanks 240 (110×110×100 cm), one water storage tank 250 (110×110×100 cm), one digital flowmeter, 2 UV sterilizers 280 (40 W), 3 coolers 230 (1.5HP), and one pure oxygen generator 270 (0.48 Kw).

The aquaculture tank 210 is designed to be inclined toward a central discharge port in the tank so that solids may be discharged smoothly. A perforation was formed at the bottom of the water level rod in the water tank to allow the solids at the bottom of the water tank to be discharged therethrough. A perforation was also formed at the top of the water level rod to allow water to drain out therethrough to remove the oil film and suspended solids. The tank 210 was also designed to include a double drain pipe to control the water level. To prevent the rainbow trout from jumping out of the tank during the rearing, all of the aquaculture tanks were covered with a mesh (mesh size 2×2 cm).

The drum filter 220 removes solids included in the discharged water discharged from the aquaculture tank 210. The drum filter 220 was embodied as a drum filter that automatically performed a backwash operation when the water level exceeds a certain level. The drum filter 220 includes a stainless steel mesh with a pore size of 80 μm, and the backwash water used to remove solids from the stainless steel mesh was reused using a pump.

The size of the biological filtration tank 240 may be set to vary depending on the implementation example to fit the size of the rearing system 200. The filling percentage of the filtration medium in the biological filtration tank 240 may be about 50%, and air may be injected by creating an air line at the bottom of the biological filtration tank 240 to mature and maintain the filtration medium. In one embodiment, the filtration medium in the biological filtration tank 240 may be implemented as a filtration medium having the characteristics as shown in Table 1 below.

### [Table 1]

TABLE 1
Characteristics of bio media

| Media | Kaldnes K1 | |
|---|---|---|
| Type | Flat cylinder | |
| Material | High density polyethylene | |
| Density | 0.92^{~}0.95 | g · cm⁻² |
| Diameter | 10.0 ± 0.2 | mm |
| Height | 7.0 ± 0.1 | mm |
| Specific surface area (m²/m³) | 500 ± 50 | m² · m⁻³ |

The user may control the overall flow rate of the rearing system 200 via the digital flow meter, and may set the flow rates of the tanks to be equal to each other using a ball valve provided in each aquaculture tank 210. The discharge water discharged from each aquaculture tank 210 may be sterilized via the UV sterilizer 280 and then flowed back into the tank to be used as inflow water. The pure oxygen generator 270 may be connected to an oxygen cone via an air line, and the amount of oxygen to be supplied to the dissolver 290 may be controlled using a solenoid valve. The water storage tank 250 may be equipped with each pump that supplies the discharged water to each cooler 230, and the water cooled through the cooler 230 may flow back into the water storage tank 250 and then may flow into the UV sterilizer 280 via the pump 260.

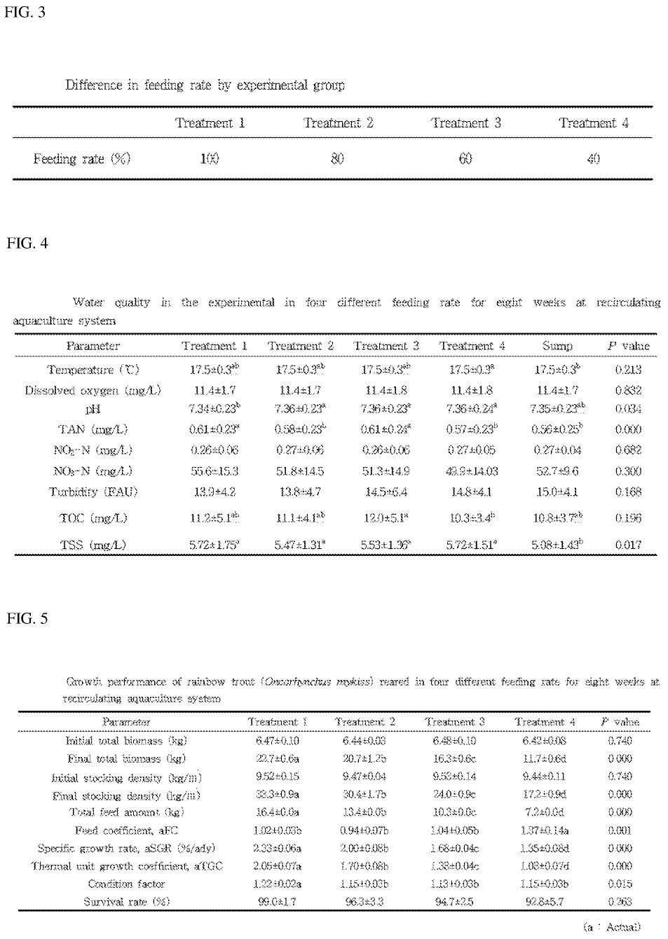

The growth estimation target fish (rainbow trout) transported to the recirculating aquaculture system 200 was fasted for 3 days before and after receiving the same therein. To verify a variation model of the correlation between FC, SGR, and TGC according to the feed supply rate, 127 rainbow trouts were housed in each aquaculture tank. The growth estimation target fishes were grouped into four experimental groups (Treatment 1 to Treatment 4). The feed was supplied to the four experimental groups (Treatment 1 to Treatment 4) at different feed rates based on the saturation amount in three repetitions. FIG. 3 is a table summarizing the different feed rates for the four experimental groups.

Every two weeks from the start of the experiment, all of the experimental groups were subjected to the saturation. Then, a saturation value was re-set. The rainbow trout used in the experiment had an average weight of 50±13 g and a total length of 16±1.9 cm, and the rainbow trouts suitable for this experimental condition were selected. During the experiment period, the photoperiod was maintained at 12L:12D (08:00-20:00, 20:00-08:00, the rearing water temperature was maintained at an optimal water temperature with the cooler, and bicarbonate was added to the water tank to maintain an appropriate pH. The feed was a commercially available mixed feed for rainbow trout, which was supplied twice at 10:00 AM and 17:00 PM at the saturation, and the remaining feed that was not eaten by the rainbow trout was collected, dried, and was excluded from the total feed amount as supplied.

The total experiment period was 8 weeks, and at the end of the experiment period, 50 fishes were randomly selected from each experimental group and individual fish weight, total length, FC, SGR, TGC, condition factor, and survival rate were measured. During the measurement, the subjects were fasted for 3 days, including before and after the measurement. SGR, FC, and TGC were calculated using the Mathematical Equation 1, the Mathematical Equation 3, and the Mathematical Equation 10, respectively. The condition factor was calculated based on (Wf/Lf3)×100, and the survival rate (%) was calculated based on (Nf/Ni)×100, where Wf represents the final average weight, Lf represents a final average body length, Ni represents the initial number of fishes, and Nf represents the final number of fishes.

FIG. 4 is a diagram showing the water quality analysis result for each experimental group for the 8-week fish rearing period.

During the fish rearing period, water temperature, dissolved oxygen (DO), pH, total ammonia nitrogen (TAN), nitrite nitrogen (NO2-N), nitrate nitrogen (NO3-N), turbidity, total organic carbon (TOC), and total suspended solids (TSS) were measured in the tank included in each experimental group. The dissolved oxygen, pH, and water temperature were measured three times a day (10:00, 14:00, 19:00) using a portable multi-item water quality meter (AM70). The total ammonia nitrogen (TAN) and nitrite nitrogen (NO2-N) were measured twice a week (Tuesday and Friday) for weeks 1 to 4 and once a week (Tuesday) for weeks 5 to 8. The nitrate nitrogen (NO3-N), the turbidity, the total organic carbon (TOC), and the total suspended solids (TSS) were measured once a week (Wednesday) for weeks 1 to 4 and once every two weeks (Wednesday) for weeks 5 to 8.

TAN and NO2-N were measured based on an absorbance using a spectrophotometer (DR 900) according to the Salicylate method (Hach method 8155) and Diazotization (Hach method 8507), respectively. NO3-N was measured using a spectrophotometer (DR 900) according to the Cadimium Reduction Method (Hach Method 8093). The turbidity was measured using a spectrophotometer (DR 900) according to the Absorptometric Method (HaCH Method 8237). The total organic carbon was measured using a spectrophotometer (DR 900) according to the Direct TNT Method (Hach method 10129). The total suspended solids (TSS) was measured according to a seawater process test standard.

As a result of water quality analysis for the total 8-week rainbow trout rearing period, there was no significant difference in the water temperature, dissolved oxygen, NO2-N, NO3-N, TSS, and TOC in each experimental group (p>0.05). In pH, Treatment 1 group had a significant difference from Treatment 2, Treatment 3, Treatment 4, and water storage tank groups (p<0.05). However, in all experimental groups, the pH was maintained within the range of 6.7 to 8.7, which is suitable for the rainbow trout rearing environment. Thus, it is believed that there will be no effect of pH on the fish. There was a significant difference between the groups in TAN (p<0.05). However, TAN was included within a range that does not affect fish growth and was maintained at a normal level. Each of the items NO3-N, turbidity, TOC, and TSS exhibited gradual accumulation in the circulating filtration aquaculture system as the experiment period elapsed. This is a natural phenomenon in the RAS environment in order to maintain a constant optimal environment for fish growth within the system, and the accumulation level was maintained within a range that does not inhibit fish growth.

FIG. 5 is a diagram showing the growth results (total weight, rearing density, SGR, and TGC) for each experimental group measured after 8 weeks of fish rearing.

Referring to FIG. 5, it may be identified that each of the total weight, rearing density, SGR, and TGC, which are the growth results for each experimental group measured after completing 8 weeks of rainbow trout rearing exhibited significant differences between Treatment 1, Treatment 2, Treatment 3, and Treatment 4 groups (p<0.05). The value thereof increased in proportional to the feed supply rate. In SGR and TGC, values in Treatment 3 and Treatment 4 groups were relatively low compared to Treatment 1 and Treatment 2 groups. There was a significant difference in the condition factor between Treatment 1 and Treatment 2, Treatment 3, and Treatment 4 groups. There was no significant difference between Treatment 2, Treatment 3, and Treatment 4 groups (p>0.05). The condition factor was highest in Treatment 1 group. In FC, Treatment 4 had a significant difference from Treatment 1, Treatment 2, and Treatment 3 (p<0.05), while there was no significant difference between Treatment 1, Treatment 2, and Treatment 3 (p>0.05). However, the treatment 4 group had the highest value, wherein the feed efficiency which is inversely related to the feed coefficient was the worst. There was no significant difference in the survival rate in all groups (p>0.05).

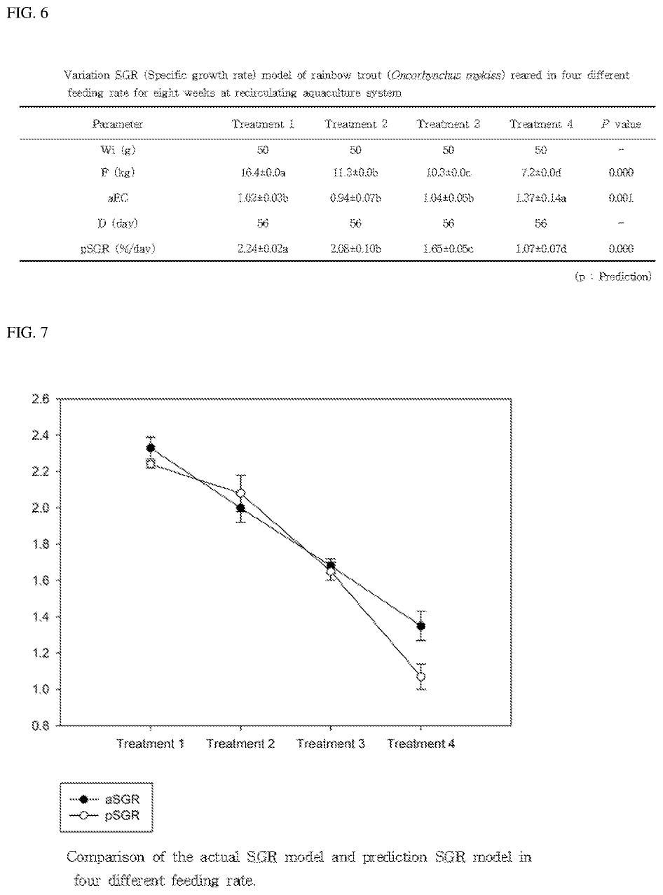

FIG. 6 is a diagram showing a modified specific growth rate (Variation SGR) value for each experimental group measured after 8 weeks of fish rearing. FIG. 7 is a diagram comparing the non-modified specific growth rate model value (actual SGR) with the modified specific growth rate model value (Prediction SGR) for each experimental group.

Referring to FIG. 6, it may be identified that there is a significant difference in the value of the modified SGR model across Treatment 1, Treatment 2, Treatment 3, and Treatment 4 groups (p<0.05). It may be identified that the experimental group with a higher feed supply rate has a higher value.

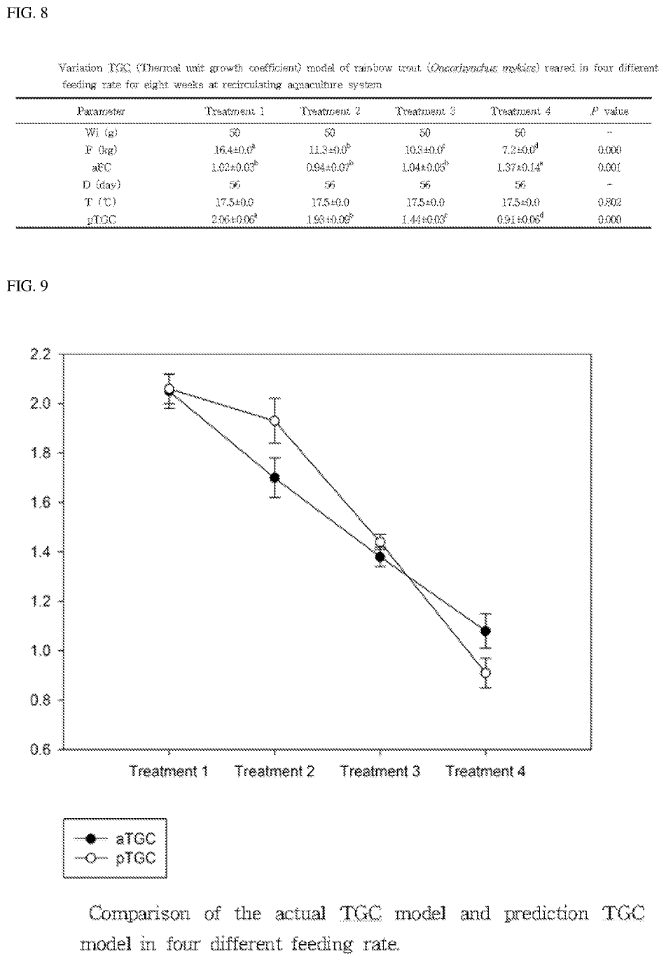

FIG. 8 is a diagram showing the modified thermal unit growth coefficient (Variation TGC) model value for each experimental group measured after 8 weeks of fish rearing. FIG. 9 is a diagram comparing the non-modified thermal unit growth coefficient model value (actual TGC) and the modified thermal unit growth coefficient model value (Prediction TGC) with each other for each experimental group.

Referring to FIG. 8, it may be identified that there is a significant difference in the value of the modified TGC model across Treatment 1, Treatment 2, Treatment 3, and Treatment 4 groups (p<0.05). It may be identified that the experimental group with a higher feed supply rate has a higher value.

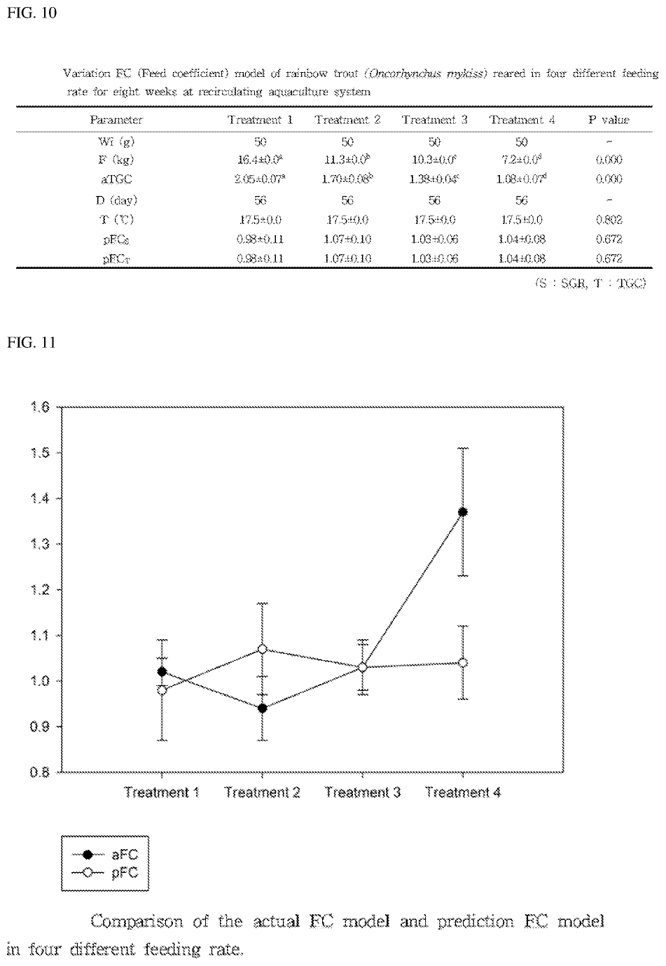

FIG. 10 is a diagram showing the modified feed coefficient (FC) model value for each experimental group measured after 8 weeks of fish rearing. FIG. 11 is a diagram comparing the non-modified feed coefficient model value (actual FC) and the modified feed coefficient model value (Prediction FC) with each other for each experimental group.

Referring to FIG. 10, it may be identified that there is no significant difference in the values of the modified FC model across Treatment 1, Treatment 2, Treatment 3, and Treatment 4 groups (p>0.05).

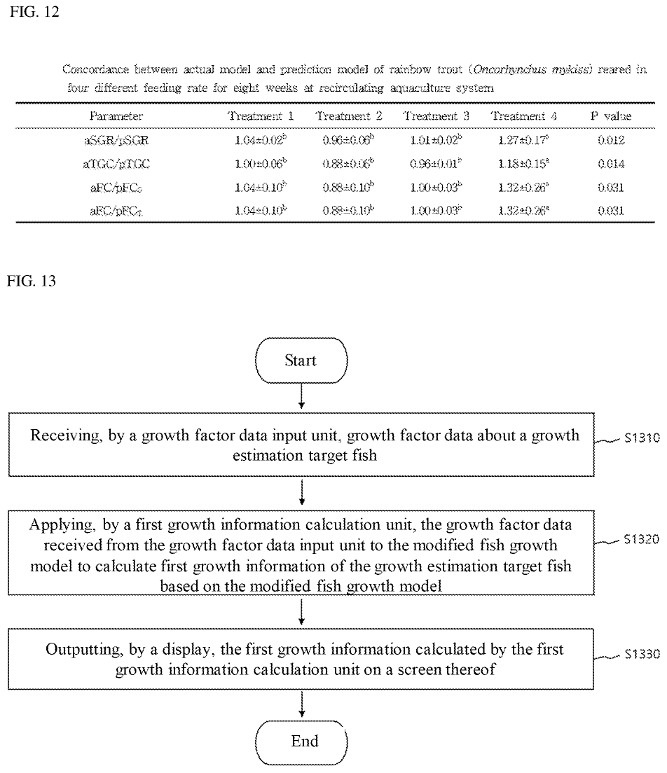

FIG. 12 is a diagram comparing the similarity between the non-modified growth model value and the modified fish growth model value for each experimental group.

Referring to FIG. 12, it may identified that the similarity between the value (aSGR) of the non-modified SGR model and the value (pSGR) of the modified SGR model is 1.01 (Treatment 3), 1.04 (Treatment 1), 0.96 (Treatment 2), and 1.27 (Treatment 4). It may be identified that the similarity between the value (aTGC) of the non-modified TGC model and the value (pTGC) of the modified TGC model is 1.00 (Treatment 1), 0.96 (Treatment 3), 0.88 (Treatment 2), and 1.18 (Treatment 4). In Treatment 3 and 4 groups, the similarity between the values of the non-modified model and the modified model was found to be low. In Treatment 3 and 4 groups, the similarity between the values of the modified model and the non-modified model is lower than a preset value, based on the inputted feed amount. Thus, it may be determined that the growth rate is outside the range of the estimated growth rate.

It may be identified that the similarity between the value (pFCs) of the modified FC model (Mathematical Equation 7) combined with the SGR model and the value (aFC) of the non-modified FC model is 0.98 (Treatment 1), 1.03±0.06 (Treatment 3), 1.04 (Treatment 4), and 1.07 (Treatment 2). It may be identified that the similarity between the value (pFCt) of the modified FC model (Mathematical Equation 13) combined with the TGC model and the non-modified FC model value (aFC) is equal to the similarity between the value (pFCs) of the modified FC model combined with the SGR model and the value (aFC) of the non-modified FC model.

FIG. 13 is a flowchart for illustrating a method for estimating fish growth based on a modified fish growth model according to an embodiment of the present disclosure.

Referring to FIG. 13, the growth factor data input unit 110 receives the growth factor data about the growth estimation target fish in step S1310. For example, the growth factor data may include at least one of the followings: the initial average weight Wi, the final average weight Wf, the total supplied feed amount F, the average water temperature T, and the rearing period D. The growth factor data may vary depending on the type of the growth model.

In one embodiment, the growth factor data input unit 110 may receive the growth factor data under user control. In another embodiment, the growth factor data input unit 110 may read the growth factor data stored in the memory 140 under user control.

The first growth information calculation unit 120 applies the data received through the growth factor data input unit 110 to the modified fish growth model to calculate the first growth information of the growth estimation target fish based on the modified fish growth model in step S1320.

In one embodiment, the growth factor data input unit 11 may receive the initial average weight Wi, the final average weight Wf, the total supplied feed amount F, and the rearing period D. The first growth information calculation unit 120 may calculate the specific growth rate (SGR) value based on the modified specific growth rate (SGR) model including the total supplied feed amount F as a variable. In one embodiment, the modified specific growth rate (SGR) model including the total supplied feed amount F as a variable may be expressed based on the Mathematical Equation 5.

In another embodiment, the growth factor data input unit 11 receives the initial average weight Wi, the final average weight Wf, the total supplied feed amount F, and the rearing period D. The first growth information calculation unit 120 may calculate the feed coefficient (FC) value based on the modified feed coefficient (FC) model including the rearing period D as a variable. In one embodiment, the modified feed coefficient (FC) model including the rearing period D as a variable may be expressed based on the Mathematical Equation 7 or the Mathematical Equation 13.

In another embodiment, the growth factor data input unit 11 receives the initial average weight Wi, the final average weight Wf, the total supplied feed amount F, and the rearing period D. The first growth information calculation unit 120 may calculate the thermal unit growth coefficient (TGC) value based on the modified thermal unit growth (TGC) model including the total supplied feed amount F as a variable. In one embodiment, the modified thermal unit growth (TGC) model including the total supplied feed amount F as a variable may be expressed based on the Mathematical Equation 12.

The display 130 outputs the first growth information calculated by the first growth information calculation unit 120 on the screen thereof in step S1330.

In one embodiment, the method for estimating fish growth based on the modified fish growth model may further include calculating, by the second growth information calculation unit (not shown), the second growth information of the growth estimation target fish based on a non-modified growth model; and verifying, by the verification unit (not shown), reliability of the modified fish growth model based on a comparing result between the first growth information calculated by the first growth information calculation unit and the second growth information calculated by the second growth information calculation unit.

For example, in response to that a similarity (the second growth information value/the first growth information value) between the first growth information and the second growth information is between a preset first threshold value (e.g., 0.9) and a preset second threshold value (e.g. 1.1), the verification unit may determine that the modified fish growth model is reliable. For example, when a similarity between the non-modified model value and the modified model value is within a specific reference range, it may be determined that the fish is actually growing normally in the field. In other words, the similarity between the non-modified model value and the modified model value may be used as a measure to identify whether the fish is actually growing normally.

In one embodiment, the verification unit may calculate a condition under which the modified fish growth model is reliable, based on the similarity between the first growth information and the second growth information, the first threshold value, and the second threshold value. For example, the verification unit may collect the rearing conditions under which the similarity between the first growth information and the second growth information is in a range between the first threshold value and the second threshold value and may associate the collected conditions with the modified fish growth model. Thus, the verification unit may determine the collected conditions as the condition under which the modified fish growth model is reliable.

The device for estimating fish growth and the method for estimating fish growth based on the modified fish growth model as described through FIGS. 1 to 13 may be implemented in a form of a recording medium containing therein instructions executable by a computer.

The methods according to the embodiments as described in the claims or specifications of the present disclosure may be implemented in the form of hardware, software, or a combination of hardware and software. The method according to the embodiment may be implemented in the form of program instructions that may be executed through various computer means and may be recorded on a computer-readable medium, or may be implemented based on a computer program combined with hardware and stored in a computer-readable recording medium.

When the method is implemented based on the software, the computer-readable storage medium that stores therein one or more programs (software modules) may be provided. The one or more programs stored in the computer-readable storage medium are configured to be executed by one or more processors in an electronic device. The one or more programs may include instructions that cause the electronic device to execute the methods according to the embodiments as described in the claims or specifications of the present disclosure.

This program (software module, software) may be stored in random access memory, non-volatile memory including flash memory, read only memory (ROM), and electrically erasable programmable ROM (EEPROM), a magnetic disc storage device, compact disc-ROM (CD-ROM), digital versatile disc (DVD), or optical storage devices in other forms, or magnetic cassette. Alternatively, the program may be stored in a memory composed of a combination of some or all thereof. Furthermore, each constituent memory may include multiple memories.

Furthermore, the program may be stored in an attachable storage device that may be accessed through a communication network such as the Internet, an intranet, a local area network (LAN), a wide area network (WAN), or a storage area network (SAN), or a combination thereof. This storage device may be connected to a device for performing the embodiment of the present disclosure through an external port. Furthermore, a separate storage device on the communications network may be able to access the device for performing the embodiments of the present disclosure.

Although the embodiments of the present disclosure have been described above, the technical idea of the present disclosure is not limited to the above embodiments. The device and method for estimating the growth of the fish based on various modified fish growth models may be implemented within the scope of the technical idea of the present disclosure.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to understand that the present disclosure may be implemented in other specific forms without changing the technical idea or essential features of the present disclosure. Therefore, it should be understood that the embodiments as described above are not restrictive but illustrative in all respects.

What is claimed is:

1. A device for estimating fish growth based on a modified fish growth model, the device comprising:
a growth factor data input unit configured to receive growth factor data including an initial average weight Wi, a final average weight Wf, a total supplied feed amount F, and a rearing period D about a growth estimation target fish;
a first growth information calculation unit configured to apply the growth factor data received from the growth factor data input unit to the modified fish growth model to calculate first growth information of the growth estimation target fish based on the modified fish growth model; and
a display for outputting the first growth information calculated by the first growth information calculation unit on a screen thereof.

2. The device for estimating fish growth based on the modified fish growth model of claim 1, wherein the first growth information calculation unit is configured to calculate a specific growth rate (SGR) value based on a modified specific growth rate (SGR) model including the total supplied feed amount F as a variable.

3. The device for estimating fish growth based on the modified fish growth model of claim 2, wherein the modified specific growth rate (SGR) model is expressed based on a following Mathematical Equation 5:
$$SGR = \frac{100 \cdot Ln ( \frac{F}{FC \cdot {W}_{i}} + 1 )}{D} \qquad [ Mathematical Equation 5 ]$$
where Ln( ) is a logarithmic function, and FC=F/WG=F/(Wf−Wi).

4. The device for estimating fish growth based on the modified fish growth model of claim 1, wherein the growth factor data input unit is configured to receive the initial average weight Wi, the final average weight Wf, the total supplied feed amount F, and the rearing period D,
wherein the first growth information calculation unit is configured to calculate a feed coefficient (FC) value based on a modified feed coefficient (FC) model including the rearing period D as a variable.

5. The device for estimating fish growth based on the modified fish growth model of claim 4, wherein the modified feed coefficient (FC) model is expressed based on a following Mathematical Equation 7:
$$FC = \frac{F}{[ Exp ( \frac{SGR \cdot D}{100} ) - 1 ]} \cdot {W}_{i} \qquad [ Mathematical Equation 7 ]$$
where Exp( ) is an exponential function, and SGR=(LnWf−LnWi)×100/D.

6. The device for estimating fish growth based on the modified fish growth model of claim 1, wherein the growth factor data input unit is configured to the initial average weight Wi, the final average weight Wf, the total supplied feed amount F, an average water temperature T, and the rearing period D, wherein the first growth information calculation unit is configured to calculate a thermal unit growth coefficient (TGC) value based on a modified thermal unit growth coefficient (TGC) model including the total supplied feed amount F as a variable.

7. The device for estimating fish growth based on the modified fish growth model of claim 6, wherein the modified thermal unit growth (TGC) model is expressed based on a following Mathematical Equation 12:
$$TGC = [ {( \frac{F}{FC \cdot {W}_{i}} + 1 )}^{\frac{1}{3}} - 1 ] \times \frac{1000 \cdot {W}_{i}^{\frac{1}{3}}}{T \cdot D} \qquad [ Mathematical Equation 12 ]$$
where FC=F/WG=F/(Wf−Wi).

8. The device for estimating fish growth based on the modified fish growth model of claim 1, wherein the growth factor data input unit is configured to the initial average weight Wi, the final average weight Wf, the total supplied feed amount F, the average water temperature T, and the rearing period D,
wherein the first growth information calculation unit is configured to calculate a feed coefficient (FC) value based on a modified feed coefficient (FC) model including the rearing period D and the average water temperature T as variables.

9. The device for estimating fish growth based on the modified fish growth model of claim 8, wherein the modified feed coefficient (FC) model is expressed based on a following Mathematical Equation 13:
$$FC = \frac{F}{[ {( \frac{TGC \cdot T \cdot D}{1000 \cdot {W}_{i}^{\frac{1}{3}}} + 1 )}^{3} - 1 ] \cdot {W}_{i}} \qquad [ Mathematical Equation 13 ]$$
where TGC=(Wf1/3−Wi1/3)×1000/(T×D).

10. The device for estimating fish growth based on the modified fish growth model of claim 1, wherein the device for estimating fish growth based on the modified fish growth model further comprises:
a second growth information calculation unit configured to calculate second growth information of the growth estimation target fish based on a non-modified growth model; and
a verification unit configured to verify reliability of the modified fish growth model based on a comparing result between the first growth information calculated by the first growth information calculation unit and the second growth information calculated by the second growth information calculation unit.

11. The device for estimating fish growth based on the modified fish growth model of claim 10, wherein in response to that a similarity between the first growth information and the second growth information is in a range between a preset first threshold value and a preset second threshold value, the verification unit is configured to determine that the modified fish growth model is reliable.

12. A method for estimating fish growth based on a modified fish growth model, the method comprising:
receiving, by a growth factor data input unit, growth factor data about a growth estimation target fish;
applying, by a first growth information calculation unit, the growth factor data received from the growth factor data input unit to the modified fish growth model to calculate first growth information of the growth estimation target fish based on the modified fish growth model; and
outputting, by a display, the first growth information calculated by the first growth information calculation unit on a screen thereof.

13. The method for estimating fish growth based on the modified fish growth model of claim 12, wherein the method for estimating fish growth based on the modified fish growth model further comprises:
calculating, by a second growth information calculation unit, second growth information of the growth estimation target fish based on a non-modified growth model; and
verifying, by a verification unit, reliability of the modified fish growth model based on a comparing result between the first growth information calculated by the first growth information calculation unit and the second growth information calculated by the second growth information calculation unit.

14. The method for estimating fish growth based on the modified fish growth model of claim 12, wherein receiving the growth factor data includes receiving an initial average weight Wi, a final average weight Wf, a total supplied feed amount F, and a rearing period D,
wherein calculating the first growth information includes calculating a specific growth rate (SGR) value based on a modified specific growth rate (SGR) model including the total supplied feed amount F as a variable.

15. The method for estimating fish growth based on the modified fish growth model of claim 12, wherein receiving the growth factor data includes receiving an initial average weight Wi, a final average weight Wf, a total supplied feed amount F, and a rearing period D,
wherein calculating the first growth information includes calculating a feed coefficient (FC) value based on a modified feed coefficient (FC) model including the rearing period D as a variable.

16. The method for estimating fish growth based on the modified fish growth model of claim 12, wherein receiving the growth factor data includes receiving an initial average weight Wi, a final average weight Wf, a total supplied feed amount F, an average water temperature T, and a rearing period D,
wherein calculating the first growth information includes calculating a thermal unit growth coefficient (TGC) value based on a modified thermal unit growth coefficient (TGC) model including the total supplied feed amount F as a variable.

17. The method for estimating fish growth based on the modified fish growth model of claim 12, wherein receiving the growth factor data includes receiving an initial average weight Wi, a final average weight Wf, a total supplied feed amount F, an average water temperature T, and a rearing period D,
wherein calculating the first growth information includes calculating a feed coefficient (FC) value based on a modified feed coefficient (FC) model including the rearing period D and the average water temperature T as variables.

18. The method of claim 1, wherein the device comprises a recording medium containing therein instructions executable by a computer.

19. The method of claim 1, wherein the device comprises a recording medium containing therein instructions executable by a computer.
